(19) United States
(12) Patent Application Publication
(10) Pub. No.: US 2003/0120767 A1
(43) Pub. Date: Jun. 26, 2003

(54) Network and wireless LAN authentication method used therein

(75) Inventor: Shinichi Morimoto, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/326,403

(22) Filed: Dec. 23, 2002

(30) Foreign Application Priority Data
Dec. 26, 2001 (JP) 2001-393073

(51) Int. Cl. G06F 15/173

(52) U.S. Cl. 709/223

(57) ABSTRACT

It is an object of the present invention to provide a network which can be connected to the network without making a management operation difficult even when a wireless LAN terminal moves. In a plurality of wireless LANs in which authentication servers are arranged, when authentication information of the wireless LAN serving as a slave is changed, the contents of the change are noticed to a wireless LAN serving as a master, and the changed authentication information is automatically sent from a management server of the wireless LAN serving as a master to a management server of the wireless LAN. The management server writes the sent authentication information in an authentication table of an authentication server.

### BACKGROUND OF THE INVENTION

1. Field of the Invention

The present invention relates to a network and a wireless LAN authentication method used therein and, more particularly, to authentication management of a wireless LAN (Local Area Network) terminal in a wireless LAN.

2. Description of the Related Art

In a conventional network in which a plurality of wireless LANs are connected to each other through a router, the authentication managements of wireless LAN terminals are independently performed in each of the plurality of wireless LANs.

In each of the wireless LANs, a management server, an authentication server, a wireless LAN base station, and a router are connected to a LAN such that the wireless LAN terminal can be connected to the LAN through the wireless LAN base station.

The management server has a user interface for performing authentication registration of a wireless LAN terminal by a network manager and generates authentication registration data. The authentication server has a function of reflecting the authentication registration data on an authentication table and a function of checking the authentication table in response to an authentication request from the wireless LAN base station and deciding whether authentication is permitted or not to make a response.

The wireless LAN base station has a function of performing wireless communication with the wireless LAN terminal, a function of transferring wireless communication to the LAN, and an authentication client function for making an authentication request to an authentication server when the wireless LAN terminal makes a connection request and regulating transfer of communication with the wireless LAN terminal to the LAN on the basis of the authentication permission/rejection result. The router connects the network to another network.

However, in the wireless LAN authentication method, authentication managements of the wireless LAN terminals are independently performed in each of the plurality of wireless LANs, and the authentication tables held by the authentication servers of the wireless LANs are individually and independently arranged in the networks. For this reason, there is a disadvantage that when a wireless LAN terminal moves to another wireless LAN, the wireless LAN terminal is not directly authenticated and cannot be connected to the network.

In this case, the following method may be used. That is, an authentication server is arranged in a wireless LAN serving as a master, and authentication requests from all the wireless LANs are processed by the wireless LAN serving as a master. However, communication of an authentication packet must be performed between networks in wireless LAN terminal authentication in another wireless LAN, such a disadvantage that an inter-network traffic increases or such an operation becomes cumbersome because the manager of the wireless LAN serving as a master must perform authentication registration of all the wireless LAN terminals are posed.

In order to solve the above disadvantages, in the method described in Japanese Unexamined Patent Publication No. 2001-043189, a server which accepts a change request of a password from a user terminal is defined as a master server first, and a server except for the server defined as a master server is defined as a slave server, the server defined as a master server performs a changing process of the password and requests the server defined as a slave server to perform a password changing process.

In the conventional wireless LAN authentication method, a server which accepts a change request of a password from a user terminal is defined as a master server, and another server is defined as a slave server. For this reason, all the servers constituting a network must be recognized by the respective servers. Each time a server is added, the added server must be recognized by the other servers. Therefore, a management operation of the network cannot be easily performed.

### SUMMARY OF THE INVENTION

It is an object of the present invention to provide a network which solves the above advantages and to which a wireless LAN terminal can be connected without making a management operation difficult even when the wireless LAN terminal moves and a wireless LAN authentication method using this network.

According to a first aspect of the present invention, there is provided a network which comprises a first wireless LAN (Local Area Network) serving as a master of a wireless LAN management system and a second wireless LAN serving as a slave of the wireless LAN management system and which includes an authentication server for authenticating a wireless LAN terminal and a management server for performing management control in the network of the management server in each of the first and second wireless LANs, wherein the management server of the first wireless LAN comprises: means for integrally managing the authentication registration data in which information related to a wireless LAN terminal to be authenticated and registered is described; and means for sending the integrally managed authentication registration data to the management server of the second wireless LAN, and wherein each of the management servers comprises an authentication table which is searched by the authentication server to check whether authentication of the wireless LAN terminal is permitted or not and which includes information of the wireless LAN terminals of all the wireless LANs.

According to a second aspect of the present invention, there is provided a wireless LAN authentication method for a network which comprises a first wireless LAN (Local Area Network) serving as a master of a wireless LAN management system and a second wireless LAN serving as a slave of the wireless LAN management system and which includes an authentication server for authenticating a wireless LAN terminal and a management server for performing management control in the network of the management server in each of the first and second wireless LANs, comprising the steps of: causing the management server of the first wireless LAN to integrally manage the authentication registration data in which information related to a wireless LAN terminal to be authenticated and registered is described; causing the management server of the first wireless LAN to send the integrally managed authentication registration data to the management server of the second wireless LAN, causing each of the management servers to have an authentication table which is searched by the authentication server to check whether authentication of the wireless LAN terminal is permitted or not and which includes information of the wireless LAN terminals of all the wireless LANs.

In the second wireless LAN, the management server may writes the authentication registration data in the authentication table of the network of the management server when authentication registration of the wireless LAN terminal is performed and transmits the authentication registration data to the management server of the first wireless LAN, and the management server of the first wireless LAN may write the authentication registration data in the authentication table of the network of the management server.

The management server of the second wireless LAN may update authentication registration data in the authentication table except for authentication registration data of the network of the management server of the second wireless LAN when the management server of the second wireless LAN receives the authentication registration data from the management server of the first wireless LAN.

The management server of the first wireless LAN may update only authentication registration data of the second wireless LAN in the authentication table when the management server of the first wireless LAN receives the authentication registration data from the management server of the second wireless LAN.

### BRIEF DESCRIPTION OF DRAWINGS

FIG. 1 is a block diagram showing configurations of networks according to an embodiment of the present invention;

FIG. 2 is a sequence chart showing closed authentication registration operations of a master network and a slave network in FIG. 1;

FIG. 3 is a sequence chart showing an authentication sequence of a wireless LAN terminal in FIG. 1.

FIG. 4 is a sequence chart showing the authentication registration operations between the master network and the slave network in FIG. 1; and

FIG. 5 is a diagram showing a configuration of an authentication server in FIG. 1.

### DETAILED DESCRIPTION OF THE PREFERRED EMBODIMENTS

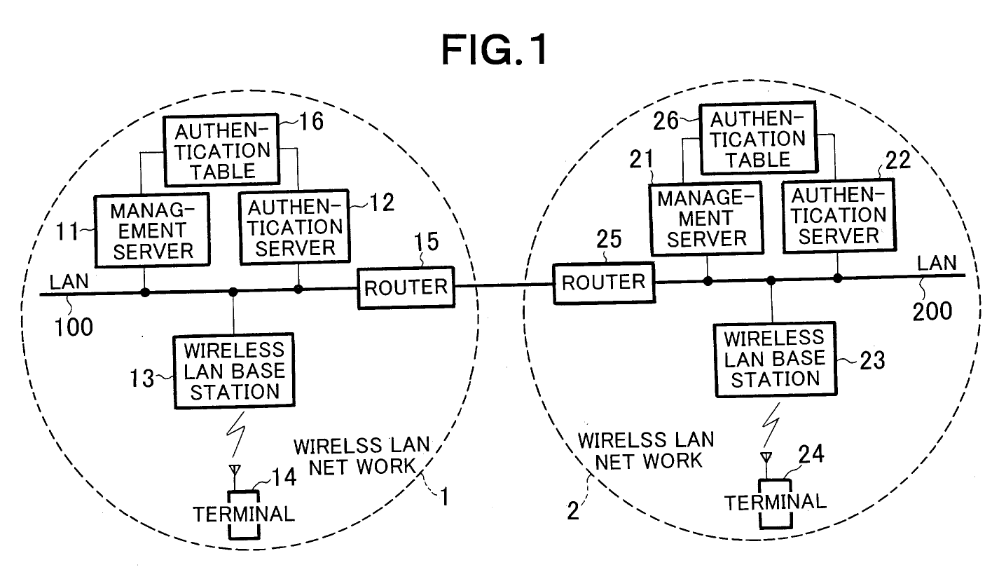

An embodiment of the present invention will be described below with reference to the accompanying drawings. FIG. 1 is a block diagram showing the configuration of networks according to an embodiment of the present invention. In FIG. 1, the network according to the embodiment of the present invention is constituted by a wireless LAN (Local Area Network) (hereinafter referred to as a master network) 1 which fixedly serves as a master and a wireless LAN (hereinafter referred to as a slave network) 2 which serves as a slave. The master network 1 and the slave network 2 correspond to wireless LANs arranged at headquarters and bases of a company, respectively, and are independent networks.

The master network 1 and the slave network 2 are constituted by management servers 11 and 21, authentication servers 12 and 22, wireless LAN base stations 13 and 23, wireless LAN terminals 14 and 24, and routers 15 and 25, respectively. The management servers 11 and 21, the authentication servers 12 and 22, the wireless LAN base stations 13 and 23, and the routers 15 and 25 are connected to LANs 100 and 200, respectively.

The management servers 11 and 21 have user interfaces used to perform authentication registration of a wireless LAN terminal by a network manager, and have a function of generating authentication registration data and a function of reflecting the authentication registration data on an authentication tables 16 and 26, respectively. The authentication servers 12 and 22 check the authentication tables 16 and 26, respectively in response to authentication requests from the wireless LAN base stations 13 and 23 and check whether authentication is permitted or not to make a response.

The wireless LAN base stations 13 and 23 have functions for performing wireless communication with the wireless LAN terminals 14 and 24, functions for transferring the wireless communication to the LANs 100 and 200, and authentication client functions for making authentication requests to the authentication servers 12 and 22 when the wireless LAN terminals 14 and 24 make connection requests and regulating transfer of communication with the wireless LAN terminals 14 and 24 to the LANs 100 and 200 on the basis of the authentication permission/rejection results. The routers 15 and 25 connect the other networks 2 and 1 with the LANs 100 and 200.

The management server 11 of the master network 1 has a function for, when authentication registration data is transmitted from the management server 21 of another wireless LAN (e.g., the slave network 2), writing the authentication registration data in an authentication table 16 and a function for transmitting the authentication registration data to the management servers 21 of all the other wireless LANs (e.g., slave networks 2).

The management server 21 of the slave network 2 has a function for, when authentication registration data is generated, writing the authentication registration data in an authentication table 26, a function for transmitting the authentication registration data to the management server 11, and a function for writing the authentication registration data transmitted from the management server 11 in the authentication table 26.

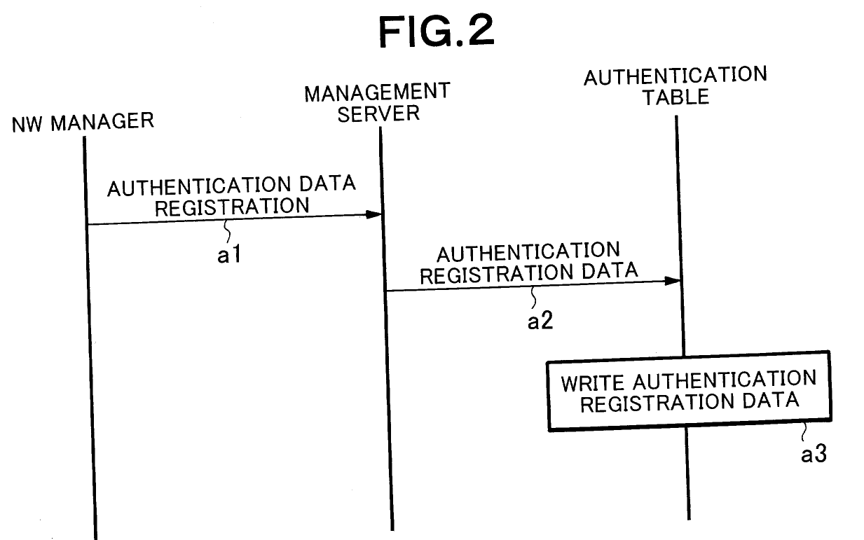

FIG. 2 is a sequence chart showing closed authentication registration operations of the master network 1 and the slave network 2 in FIG. 1. The closed authentication registration operations of the master network 1 and the slave network 2 will be described below with reference to FIGS. 1 and 2.

A network (NW) manager registers authentication data (in general, MAC (Media Access Control) addresses) of the wireless LAN terminals 14 and 24 by using the management servers 11 and 21 (“a1” in FIG. 2).

The management servers 11 and 21 reflect registration information from the network manager on the authentication registration data managed by the management servers 11 and 21, transmit the authentication registration data to the authentication tables 16 and 26, respectively (“a2” in FIG. 2), and write the authentication registration data in the authentication tables 16 and 26, respectively (“a3” in FIG. 2).

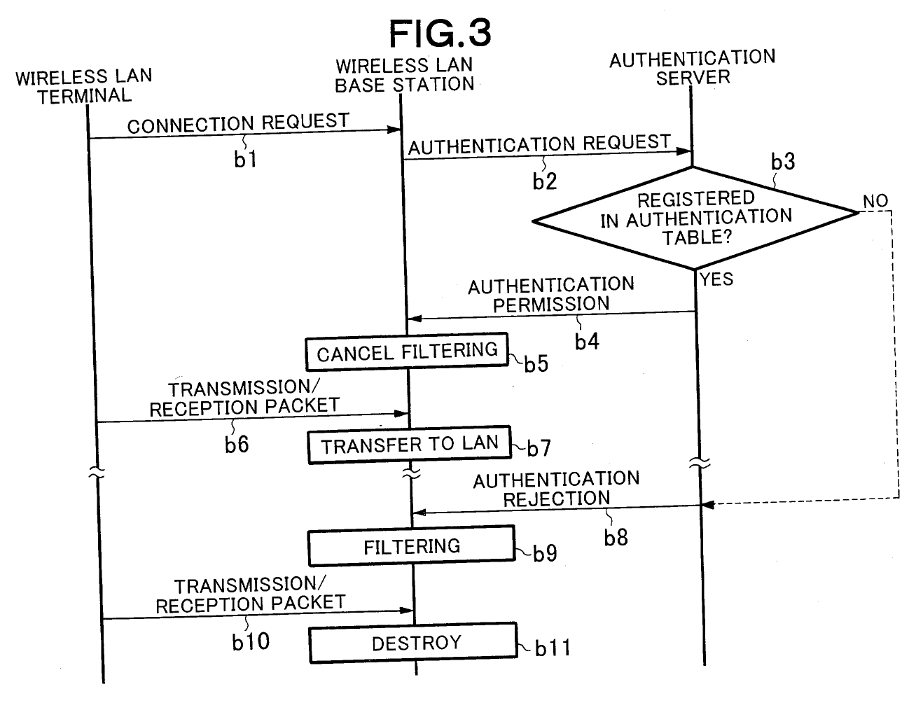

FIG. 3 is a sequence chart showing an authentication sequence of the wireless LAN terminal 14 in FIG. 1. The authentication sequence of the wireless LAN terminal 14 will be described below with reference to FIGS. 1 and 3.

When the wireless LAN terminal 14 makes a connection request to the wireless LAN base station 13 (“b1” in FIG. 3), the wireless LAN base station 13 transmits an authentication request added with the authentication data of the wireless LAN terminal 14 to the authentication server 12 (“b2” in FIG. 3).

The authentication server 12 compares the authentication data with the authentication table 16 to check whether the authentication data is registered in the authentication table 16 of the wireless LAN terminal 14 or not (“b3” in FIG. 3). If the authentication data is registered as the result of the check, the authentication server 12 transmits authentication permission to the wireless LAN base station 13 (“b4” in FIG. 3).

When the wireless LAN base station 13 receives the authentication permission from the authentication server 12, the wireless LAN base station 13 cancels filtering to the wireless LAN terminal 14 in an internal bridge (not shown) (“b5” in FIG. 3) and transfers a transmission/reception packet “b6” from the wireless LAN terminal 14 to the LAN 100 to make it possible to perform communication (“b7” in FIG. 3).

If the authentication data is not registered as the check result, the authentication server 12 transmits authentication reject to the wireless LAN base station 13 (“b8” in FIG. 3). When the wireless LAN base station 13 receives the authentication rejection from the authentication server 12, the wireless LAN base station 13 performs filtering to the wireless LAN terminal 14 in the internal bridge (“b9” in FIG. 3) and destroys a transmission/reception packet “b10” from the wireless LAN terminal 14 to make it impossible to perform communication (“b11” in FIG. 3).

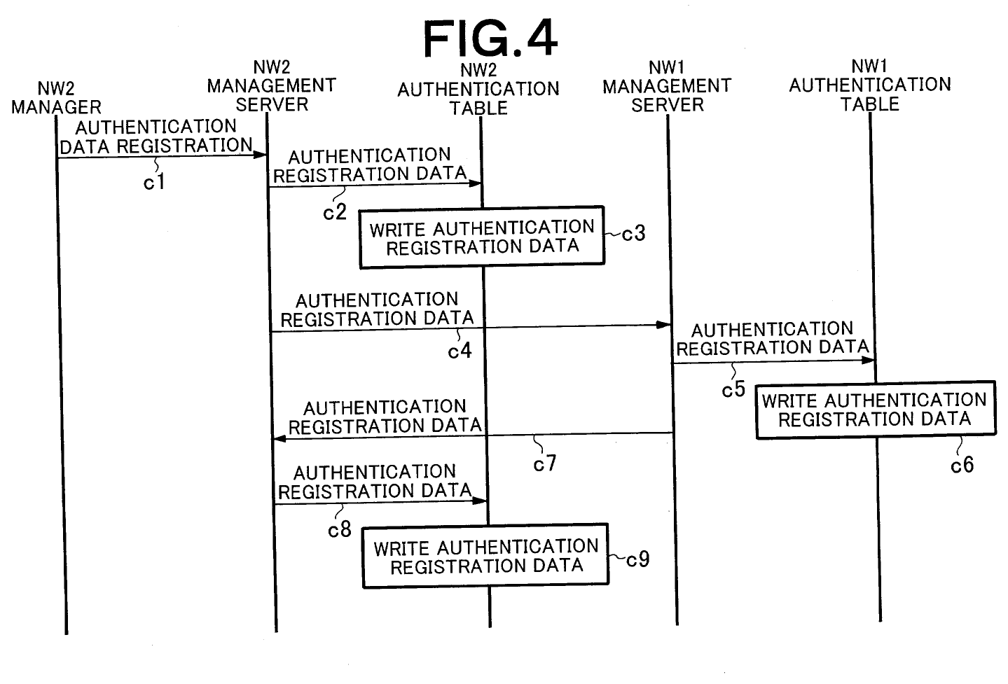

FIG. 4 is a sequence chart showing an authentication registration operation between the master network 1 and the slave network 2 in FIG. 1. The authentication registration operation between the master network 1 and the slave network 2 will be described below with reference to FIGS. 1 and 4.

When a network manager of the slave network 2 registers authentication data (in general, a MAC address) of the wireless LAN terminal 24 by using the management server 21 (“c1” in FIG. 4), the management server 21 reflects registration information obtained by the network manager on the authentication registration data managed by the management server 21, transmits the authentication registration data to an authentication table 26 (“c2” in FIG. 4), and writes the authentication registration data in the authentication table 26 (“c3” in FIG. 4). The authentication server 22 also transmits the authentication registration data to the management server 11 of the master network 1 (“c4” in FIG. 4).

The management server 11 reflects the authentication registration data from the authentication server 22 on the authentication registration data managed by the management server 11, transmits the authentication registration data to the authentication table 16 (“c5” in FIG. 4), and writes the authentication registration data in the authentication table 16 (“c6” in FIG. 4).

The management server 11 transmits the authentication registration data to the management server 21 of the slave network 2 (“c7” in FIG. 4). The management server 21 transmits the authentication registration data from the management server 11 to the authentication table 26 (“c8” in FIG. 4) and writes the authentication registration data in the authentication table 26 (“c9” in FIG. 4). Although only the slave network 2 is shown in FIG. 4, authentication registration data is transmitted to the respective management servers of the wireless LANs if a plurality of wireless LANs exist.

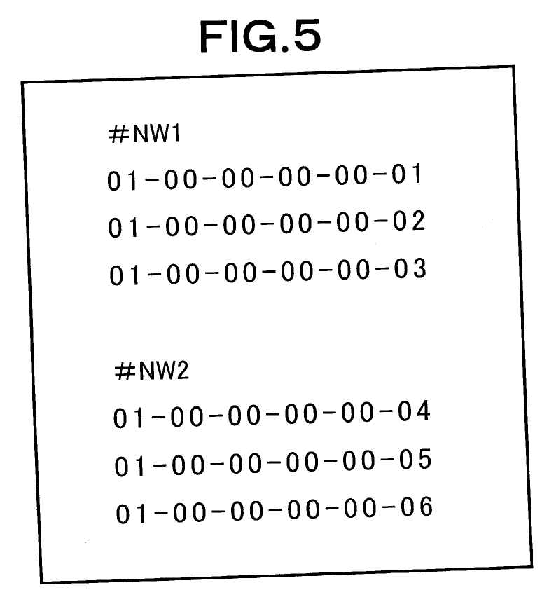

FIG. 5 is a diagram showing a configuration of authentication tables 16 and 26 of the authentication servers 12 and 22 in FIG. 1. FIG. 5 shows an example obtained when the authentication data is a MAC address and permits the described MAC address to be authenticated. In the authentication tables 16 and 26, it is considered that authentication data can be managed for each wireless LAN. The authentication registration data may have a form as shown in FIG. 5. In this case, the authentication servers 12 and 22 directly use the authentication registration data as authentication tables 16 and 26, respectively.

In this manner, in this embodiment, since the authentication tables 16 and 26 of the authentication servers 12 and 22 of the master networks 1 and 2 are made equal to each other, even though a wireless LAN terminal registered in a certain wireless LAN moves to another wireless LAN, authentication can be permitted, and the wireless LAN terminal can be connected to the network. In this case, in this embodiment, operation management of networks is not made difficult, and an increase in inter-network traffic and a cumbersome operation are not caused.

As has been described above, in a network constituted by a plurality of wireless LANs in which authentication servers for authenticating wireless LAN terminals and management servers for performing management control in their networks are arranged, authentication information is sent from the management server to another wireless LAN in a change in authentication information in the network of the management server, and authentication information from another wireless LAN is written in an authentication table by the management server and stored. For this reason, even when a wireless LAN terminal moves to a network, the wireless LAN terminal can be advantageously connected to the network without making operation management difficult and causing an increase in inter-network traffic or a cumbersome operation.

What is claimed is:

1. A network which comprises a first wireless LAN (Local Area Network) serving as a master of a wireless LAN management system and a second wireless LAN serving as a slave of the wireless LAN management system and which includes an authentication server for authenticating a wireless LAN terminal and a management server for performing management control in the network of the management server in each of the first and second wireless LANs,
wherein the management server of the first wireless LAN comprises:
means for integrally managing the authentication registration data in which information related to a wireless LAN terminal to be authenticated and registered is described; and
means for sending the integrally managed authentication registration data to the management server of the second wireless LAN, and
wherein each of the management servers comprises an authentication table which is searched by the authentication server to check whether authentication of the wireless LAN terminal is permitted or not and which includes information of the wireless LAN terminals of all the wireless LANs.

2. The network according to claim 1, wherein
in the second wireless LAN, the management server writes the authentication registration data in the authentication table of the network of the management server when authentication registration of the wireless LAN terminal is performed and transmits the authentication registration data to the management server of the first wireless LAN, and
the management server of the first wireless LAN writes the authentication registration data in the authentication table of the network of the management server.

3. The network according to claim 1, wherein the management server of the second wireless LAN updates authentication registration data in the authentication table except for authentication registration data of the network of the management server of the second wireless LAN when the management server of the second wireless LAN receives the authentication registration data from the management server of the first wireless LAN.

4. The network according to claim 1, wherein the management server of the first wireless LAN updates only authentication registration data of the second wireless LAN in the authentication table when the management server of the first wireless LAN receives the authentication registration data from the management server of the second wireless LAN.

5. A wireless LAN authentication method for a network which comprises a first wireless LAN (Local Area Network) serving as a master of a wireless LAN management system and a second wireless LAN serving as a slave of the wireless LAN management system and which includes an authentication server for authenticating a wireless LAN terminal and a management server for performing management control in the network of the management server in each of the first and second wireless LANs, comprising the steps of:
causing the management server of the first wireless LAN to integrally manage the authentication registration data in which information related to a wireless LAN terminal to be authenticated and registered is described;
causing the management server of the first wireless LAN to send the integrally managed authentication registration data to the management server of the second wireless LAN,
causing each of the management servers to have an authentication table which is searched by the authentication server to check whether authentication of the wireless LAN terminal is permitted or not and which includes information of the wireless LAN terminals of all the wireless LANs.

6. The wireless LAN authentication method according to claim 5, wherein
in the second wireless LAN, the management server writes the authentication registration data in the authentication table of the network of the management server when authentication registration of the wireless LAN terminal is performed and transmits the authentication registration data to the management server of the first wireless LAN, and
the management server of the first wireless LAN writes the authentication registration data in the authentication table of the network of the management server.

7. The wireless LAN authentication method according to claim 5, wherein the management server of the second wireless LAN updates authentication registration data in the authentication table except for authentication registration data of the network of the management server of the second wireless LAN when the management server of the second wireless LAN receives the authentication registration data from the management server of the first wireless LAN.

8. The wireless LAN authentication method according to claim 5, wherein the management server of the first wireless LAN updates only authentication registration data of the second wireless LAN in the authentication table when the management server of the first wireless LAN receives the authentication registration data from the management server of the second wireless LAN.
